(19) United States
(12) Patent Application Publication
(10) Pub. No.: US 2026/0290717 A1
(43) Pub. Date: Sep. 24, 2026

(54) DUAL-POWER TRANSFER SWITCH

(71) Applicant: Schneider Electric Industries SAS, Rueil-Malmaison (FR)

(72) Inventors: Jian Wu, Shanghai (CN); Zhenzhong Liu, Shanghai (CN); Yanming Pan, Shanghai (CN); Junjie Zhou, Shanghai (CN)

(73) Assignee: Schneider Electric Industries SAS, Rueil-Malmaison (FR)

(21) Appl. No.: 19/569,834

(22) Filed: Mar. 17, 2026

(30) Foreign Application Priority Data
Mar. 21, 2025 (CN) 202510340071.4

(51) Int. Cl. H01H 3/32; H01H 9/02

(52) U.S. Cl. CPC H01H 3/32; H01H 9/02

(57) ABSTRACT

Embodiments of the disclosure provide a dual-power transfer switch including a support, an opening and closing mechanism, and a buffer mechanism. The opening and closing mechanism includes a driving member and a pivot shaft. The driving member is provided with a first hole. The pivot shaft is sleeved in the first hole and non-rotatably engaged with the first hole. The pivot shaft is pivotally connected to the support to allow the driving member to perform a closing rotation or an opening rotation around an axis of the pivot shaft. The buffer mechanism includes a flywheel and a one-way bearing. The flywheel is sleeved on the pivot shaft via the one-way bearing. The one-way bearing is configured to allow the flywheel to rotate along with the pivot shaft when the driving member performs the closing rotation.

### CROSS-REFERENCE TO RELATED APPLICATION

This application claims priority to Chinese Patent Application No. 202510340071.4, filed on March 21, 2025, and entitled “DUAL-POWER TRANSFER SWITCH”, the entirety of which is incorporated herein by reference.

### FIELD OF THE INVENTION

Embodiments of the present disclosure generally relate to the field of electrical equipment, and in particular, to a dual-power transfer switch.

### BACKGROUND

In some electrical devices, in order to avoid power interruption of the devices caused by a power supply fault, the devices are generally configured with two independent power supplies, namely a normal power supply and a standby power supply. The normal power supply and the standby power supply selectively supply power to the devices through a dual-power transfer switch.

The dual-power transfer switch includes two contact assemblies, and each contact assembly includes a fixed contact and a movable contact mounted on the movable contact bracket. The movable contact bracket can rotate between an open position and a closed position. When the movable contact bracket is in the open position, the movable contact on the movable contact bracket is separated from the fixed contact, and at this point, the contact assembly is in an open state. When the movable contact bracket is in the closed position, the movable contact on the movable contact bracket abuts against the fixed contact, and at this point, the contact assembly is in a closed state. When one of the two contact assemblies is in the closed state, the other is in the open state, so that one of the normal power supply and the standby power supply supplies power to the devices.

### SUMMARY

The present disclosure provides a dual-power transfer switch including: a support, an opening and closing mechanism, and a buffer mechanism. The opening and closing mechanism includes a driving member and a pivot shaft. The driving member is provided with a first hole. The pivot shaft is sleeved in the first hole and non-rotatably engaged with the first hole. The pivot shaft is pivotally connected to the support to allow the driving member to perform a closing rotation or an opening rotation around an axis of the pivot shaft. The buffer mechanism includes a flywheel and a one-way bearing. The flywheel is sleeved on the pivot shaft via the one-way bearing. The one-way bearing is configured to allow the flywheel to rotate along with the pivot shaft when the driving member performs the closing rotation.

In some embodiments, a hole wall of the first hole is provided with a first cut surface, an outer peripheral wall of a first end of the pivot shaft is provided with a second cut surface, and the first cut surface mates with the second cut surface to limit a relative rotation between the driving member and the pivot shaft; and the one-way bearing is sleeved on a second end of the pivot shaft.

In some embodiments, the driving member is sleeved on a first end of the pivot shaft. The one-way bearing is sleeved on a second end of the pivot shaft, and the second end of the pivot shaft is provided with an axial limiting structure for limiting axial positions of the one-way bearing and the flywheel on the pivot shaft.

In some embodiments, the driving member is further provided with a second hole. The opening and closing mechanism further includes an output shaft, the output shaft is sleeved in the second hole and is connected to a movable contact bracket. When the driving member performs the closing rotation or the opening rotation, the output shaft drives the movable contact bracket to rotate, so that the movable contact abuts against or is separated from a corresponding fixed contact.

In some embodiments, the dual-power transfer switch is provided with two opening and closing mechanisms and two buffer mechanisms, and the one-way bearing of each buffer mechanism is sleeved on the pivot shaft of a corresponding opening and closing mechanism.

In some embodiments, the flywheels of the two buffer mechanisms partially overlap each other.

In some embodiments, the flywheel includes: a sleeve portion sleeved on the one-way bearing; and a first wheel body extending outwardly from an outer peripheral wall of the sleeve portion. A thickness of the first wheel body is smaller than an axial length of the sleeve portion.

In some embodiments, the flywheel further includes at least one second wheel body sleeved on the sleeve portion. Among the first wheel body and the at least one second wheel body stacked together, a linkage structure is disposed between every two adjacent wheel bodies, and the linkage structure is configured to: when the driving member performs the closing rotation in a closing direction, allow one of every two adjacent wheel bodies to drive the other wheel body to rotate after rotating by a predetermined angle in the closing direction .

In some embodiments, the linkage structure includes: at least one first arcuate groove disposed on one of every two adjacent wheel bodies; and at least one sliding block disposed on the other of every two adjacent wheel bodies, and slidably engaged with the at least one first arcuate groove.

In some embodiments, an elastic return member is disposed between every two adjacent wheel bodies.

It should be understood that the content described in this content section is not intended to limit the key features or important features of embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a perspective view of a partial structure of a dual-power transfer switch according to some embodiments of the present disclosure;

FIGS. 2 and 3 illustrate schematic diagrams of the dual-power transfer switch shown in FIG. 1 from different viewing angles, where the driving member is in a ready-to-close position;

FIGS. 4 and 5 illustrate schematic diagrams of the dual-power transfer switch shown in FIG. 1 from different viewing angles, where the driving member is in a closing limit position.

FIG. 6 illustrates a schematic diagram of the dual-power transfer switch shown in FIG. 1, where the driving member is in a ready-to-open position;

FIG. 7 illustrates a schematic diagram of the dual-power transfer switch shown in FIG. 1, where the driving member is in an opening limit position;

FIG. 8 illustrates a schematic perspective view of a partial structure of a dual-power transfer switch according to some embodiments of the present disclosure;

FIG. 9 illustrates a further schematic perspective view of the dual-power transfer switch shown in FIG. 8, for ease of description, an opening and closing mechanism and a buffer mechanism are omitted in FIG. 9;

FIG. 10 illustrates a partially exploded view of the opening and closing mechanism and the buffer mechanism shown in FIG. 9;

FIG. 11 illustrates an enlarged schematic diagram of portion A in FIG. 10;

FIG. 12 illustrates a schematic perspective view of a variation of the buffer mechanism shown in FIG. 9, where the sliding block is located at a first end of a first arcuate groove;

FIG. 13 illustrates a further schematic perspective view of the buffer mechanism shown in FIG. 12, where the sliding block slides to a second end of the first arcuate groove, and the elastic return member is stretched; and

FIG. 14 illustrates an exploded view of the buffer mechanism shown in FIG. 12.

The present summary is provided only by way of example, and not limitation. Other aspects of the present disclosure will be appreciated in view of the entirety of the present disclosure, including the entire text, claims, and accompanying figures.

### DETAILED DESCRIPTION

Embodiments of the present disclosure will be described in more detail below with reference to the accompanying drawings. While embodiments of the present disclosure are shown in the drawings, it should be understood that the present disclosure may be implemented in various forms and should not be limited by embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

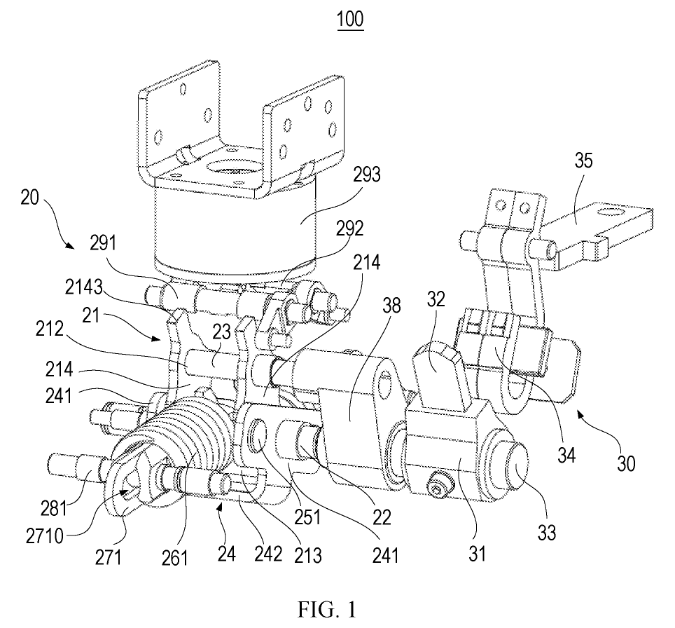

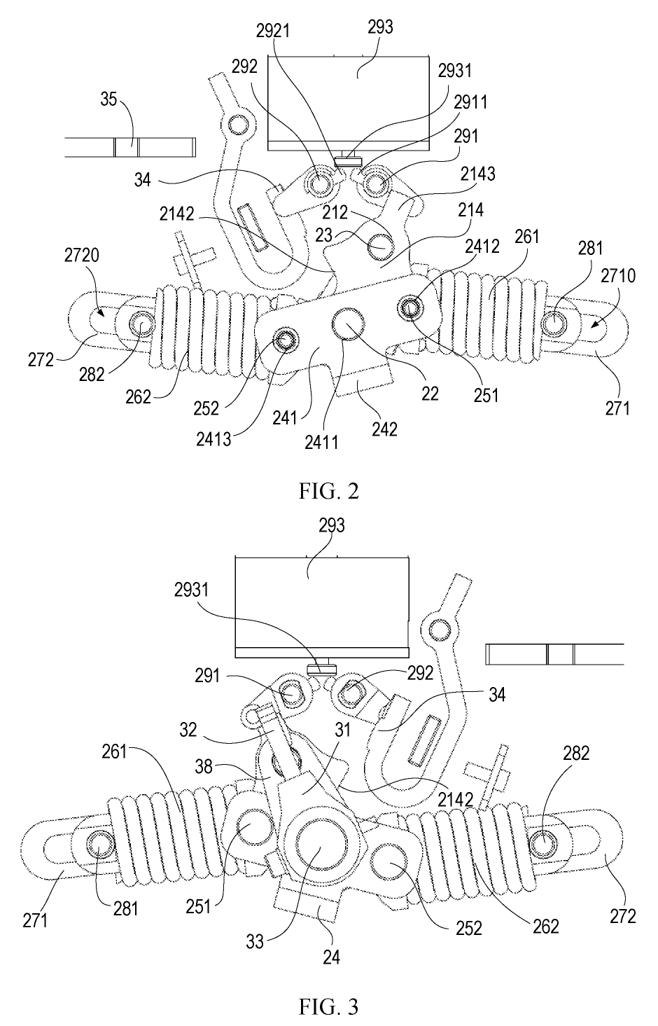

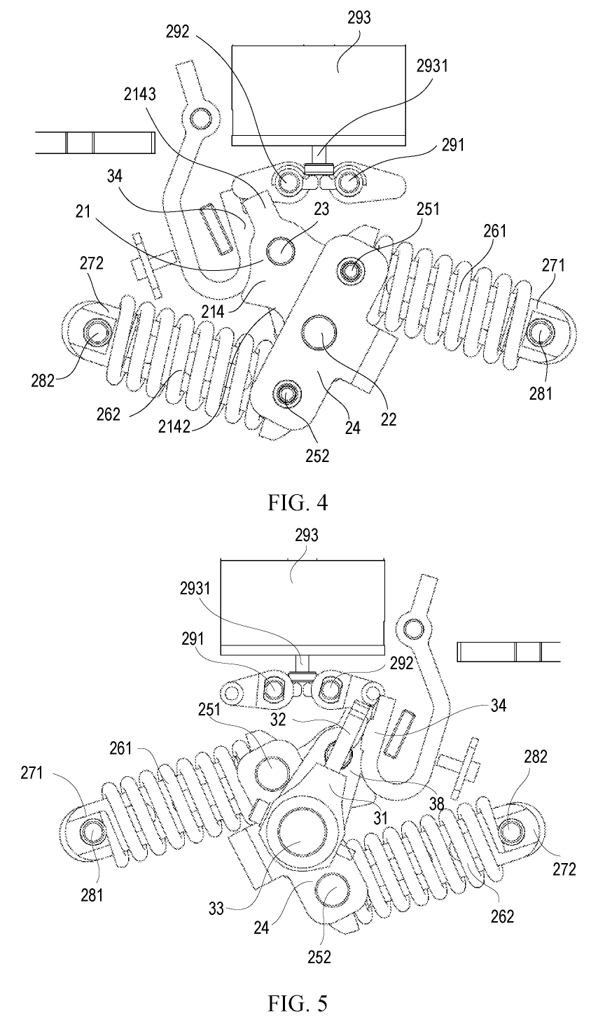

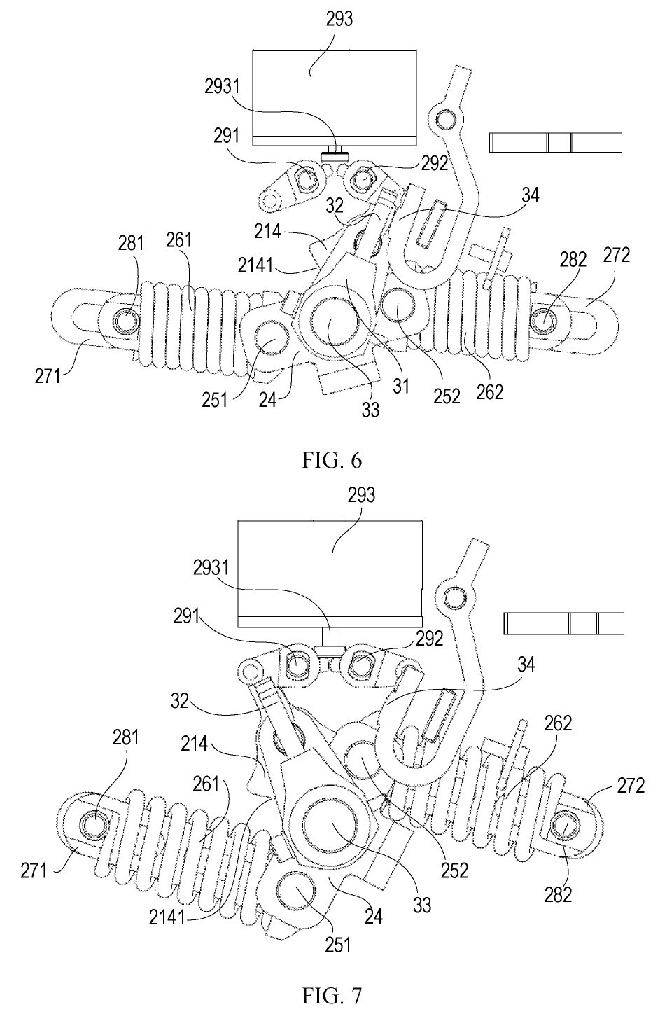

FIGS. 1 to 7 illustrate an example of a dual-power transfer switch 100 provided according to some embodiments of the present disclosure, showing closing and opening processes of the contact assembly 30. The dual-power transfer switch may be, but is not limited to, a fast transfer switch. FIG. 1 illustrates a perspective view of a partial structure of the dual-power transfer switch 100. FIGS. 2 and 3 illustrate schematic diagrams of the dual-power transfer switch 100 shown in FIG. 1 from different viewing angles, where the driving member 21 is in a ready-to-close position. FIGS. 4 and 5 illustrate schematic diagrams of the dual-power transfer switch 100 shown in FIG. 1 from different viewing angles, where the driving member 21 is in a closing limit position. FIG. 6 illustrates a further schematic diagram of the dual-power transfer switch 100 shown in FIG. 1, where the driving member 21 is in a ready-to-open position. FIG. 7 illustrates a further schematic diagram of the dual-power transfer switch 100 shown in FIG. 1, where the driving member 21 is in an opening limit position.

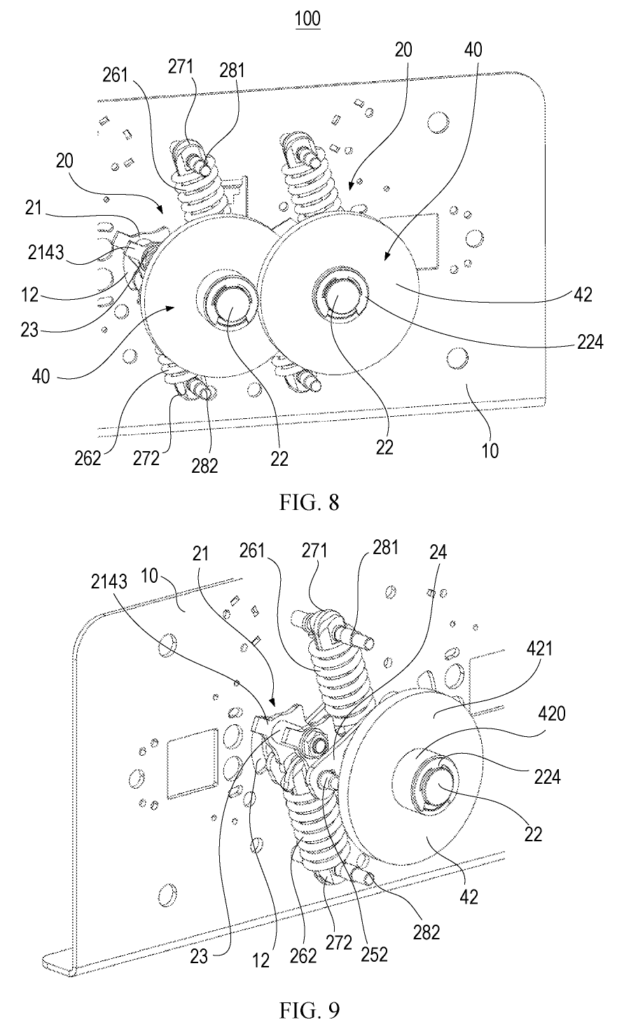

Referring to FIG. 1, the dual-power transfer switch 100 includes a housing (not shown in FIG. 1, the housing includes, for example, a support 10 shown in FIG. 8), and two opening and closing mechanisms 20 and two contact assemblies 30 mounted on the housing. For ease of description, only one opening and closing mechanism 20 and one contact assembly 30 are shown in FIG. 1, and the structure of the other opening and closing mechanism 20 and the other contact assembly 30 not shown is similar to that of the opening and closing mechanism 20 and the contact assembly 30 shown in FIG. 1. The opening and closing mechanism 20 is configured to control switching of a corresponding contact assembly 30 between an open state and a closed state. It can be understood that when one contact assembly 30 is in the open state, the other contact assembly 30 is in the closed state. That is, the two contact assemblies 30 are not in the closed state at the same time. The contact assembly 30 in the closed state allows a corresponding normal power supply or standby power supply to supply power to a load.

Referring to FIGS. 1 and 2, the contact assembly 30 includes a movable contact bracket 31, a movable contact 32, and a fixed contact 34. The movable contact bracket 31 is rotatably disposed on the pivot shaft 33, and the movable contact bracket 31 is connected to a load terminal through, for example, a braid, and the load terminal is connected to an electrical device. The movable contact 32 extends from the movable contact bracket 31. The fixed contact 34 is configured to be connected to an inlet terminal 35 through another braid (not shown), and the inlet terminal 35 is connected to the corresponding normal power supply or the standby power supply. In some embodiments, the fixed contact 34 may be pivotally connected to a suitable support of the dual-power transfer switch 100 via a pivot shaft (not labeled in the figure), and the fixed contact 34 may be subjected to an elastic biasing force from a contact pressure member (not shown).

The movable contact bracket 31 and the movable contact 32 thereon can rotate between an opening limit position and a closing limit position, so that the contact assembly 30 can switch between the open state and the closed state. When the contact assembly 30 is in the open state, the movable contact 32 remains separated from the fixed contact 34, and the power supply connected to the fixed contact 34 does not supply power to the load. When the contact assembly 30 is in the closed state, the movable contact 32 remains in abutment with the fixed contact 34, and the power supply connected to the fixed contact 34 supplies power to the load.

The rotation of the movable contact 32 between the opening limit position and the closing limit position is driven by the opening and closing mechanism 20. The opening and closing mechanism 20 includes, for example, a driving member 21, a pivot shaft 22, an output shaft 23, a mounting base 24, a first driving shaft 251, a second driving shaft 252, a first spring 261, a second spring 262, a first rod 271, a second rod 272, a first positioning pin 281, a second positioning pin 282, a first stopper 291, a second stopper 292, and a driving device 293.

In some embodiments, the mounting base 24 is U-shaped, and includes a second connecting plate 242 and two opposite mounting plates 241, and the two mounting plates 241 are connected to each other via the second connecting plate 242. Each mounting plate 241 includes a first through hole 2411, and a second through hole 2412 and a third through hole 2413 located on two sides of the first through hole 2411. The first through holes 2411 on the two mounting plates 241 are aligned with each other, the second through holes 2412 on the two mounting plates 241 are aligned with each other, and the third through holes 2413 on the two mounting plates 241 are aligned with each other.

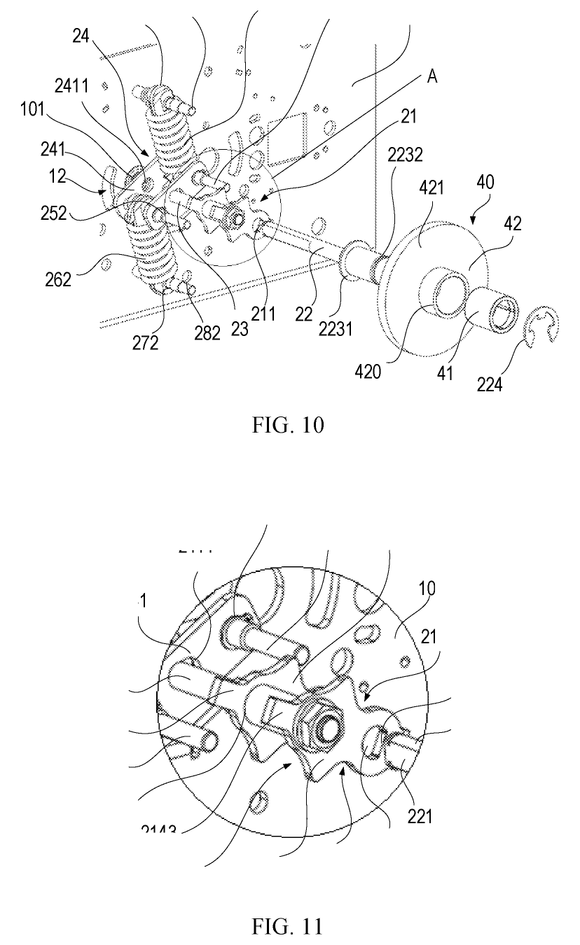

In some embodiments, the driving member 21 is U-shaped, and includes a first connecting plate 213 and two opposite driving plates 214, and the two driving plates 214 are connected to each other via the first connecting plate 213. An end of each driving plate 214 close to the first connecting plate 213 is provided with a first hole (referring to a first hole 211 shown in FIG. 10), and an end of each driving plate 214 away from the first connecting plate 213 is provided with a second hole 212. The first holes of the two driving plates 214 are aligned with each other, and the second holes 212 of the two driving plates 214 are aligned with each other.

The two mounting plates 241 of the mounting base 24 are located outside the two driving plates 214 of the driving member 21. The pivot shaft 22 is sleeved in the first hole of each driving plate 214 and the first through hole 2411 of each mounting plate 241. The driving member 21 is pivotally connected to the housing (for example, the support 10) of the dual-power transfer switch 100 via the pivot shaft 22, so as to be rotatable between the closing limit position and the opening limit position. A rotation of the driving member 21 from the opening limit position to the closing limit position may be referred to as a closing rotation of the driving member 21. A rotation of the driving member 21 from the closing limit position to the opening limit position may be referred to as an opening rotation of the driving member 21. The mounting seat 24 is pivotally connected to the pivot shaft 22 via the first through holes 2411, and the mounting seat 24 can rotate relative to the pivot shaft 22.

The output shaft 23 is parallel to the pivot shaft 22. A first end of the output shaft 23 is sleeved in the second hole 212 of each driving plate 214, a second end of the output shaft 23 is connected to a first end of a crank arm 38, and a second end of the crank arm 38 is non-rotatably connected to the movable contact bracket 31. Therefore, when the driving member 21 rotates around an axis of the pivot shaft 22, the output shaft 23 drives the movable contact bracket 31 to rotate around an axis of the pivot shaft 33 via the crank arm 38, so that the movable contact 32 abuts against or is separated from the fixed contact 34. The axis of the pivot shaft 22 coincides with the axis of pivot shaft 33. It can be understood that the rotation of the driving member 21 is synchronized with the rotation of the movable contact bracket 31. When the driving member 21 is in the opening limit position, the movable contact bracket 31 and the movable contact 32 are also in an opening limit position. When the driving member 21 is in the closing limit position, the movable contact bracket 31 and the movable contact 32 are also in a closing limit position. A rotation of the movable contact bracket 31 from the opening limit position to the closing limit position may be referred to as a closing rotation of the movable contact bracket 31. A rotation of the movable contact bracket 31 from the closing limit position to the opening limit position may be referred to as an opening rotation of the movable contact bracket 31.

A latching portion 2143 is formed at an end of each driving plate 214 away from the first connecting plate 213. A first engaging groove 2141 (referring to FIG. 7, and reference may be made to a first engaging groove 2141 shown in FIG. 11) is formed on a side of each driving plate 214, and a second engaging groove 2142 is formed on the other side of each driving plate 214. In some embodiments, each driving plate 214 is symmetrical with respect to a plane defined by a center line of its first hole and a center line of its second hole 212.

The first driving shaft 251 is sleeved in the second through hole 2412 of each mounting plate 241. A first end of the first rod 271 is located between the two mounting plates 241 and is pivotally connected to the first driving shaft 251. A second end of the first rod 271 is provided with an elongated hole 2710. The first locating pin 281 is positioned on the housing (e.g., the support 10) and passes through the elongated hole 2710. The first spring 261 is sleeved on the first rod 271 and is clamped between the first driving shaft 251 and the first positioning pin 281.

The second driving shaft 252 is sleeved in the third through hole 2413 of each mounting plate 241. A first end of the second rod 272 is located between the two mounting plates 241 and pivotally connected to the second driving shaft 252. A second end of the second rod 272 is provided with an elongated hole 2720. The second locating pin 282 is positioned on the housing (e.g., the support 10) and passes through the elongated hole 2720. The second spring 262 is sleeved on the second rod 272 and is clamped between the second driving shaft 252 and the second positioning pin 282.

The first stopper 291 and the second stopper 292 are respectively pivotally connected to a suitable structure (e.g., the support 10) of the housing. The first stopper 291 and the second stopper 292 are spaced apart along a rotation trajectory of the latching portion 2143. The first stopper 291 and the second stopper 292 each have a stop position and an avoidance position. The first stopper 291 and the second stopper 292 are held in the stop positions under the action of an unshown holding mechanism, so as to prevent the latching portion 2143 from accidentally rotating past the adjacent first stopper 291 or the second stopper 292. The first stopper 291 and the second stopper 292 can rotate to avoidance positions under the driving of the driving device 293 to allow the latching portion 2143 to rotate past the first stopper 291 and the second stopper 292.

For example, in some embodiments, the first stopper 291 and the second stopper 292 each include a shaft member, and the shaft member may be pivotally connected to the housing (for example, the support 10) so as to be rotatable around its own axis. The first stopper 291 and the second stopper 292 are each provided with two grooves (not shown in the figure). When the first stopper 291 and the second stopper 292 are both in the stop position, the first stopper 291 or the second stopper 292 can abut against the latching portions 2143 of the driving member 21, thereby preventing the latching portions 2143 from rotating past the first stopper 291 or the second stopper 292 to continue to rotate. When the first stoper 291 and the second stoper 292 are both in the avoidance position, the first stoper 291 and the second stoper 292 avoid the latching portions 2143 of the driving member 21 through their respective grooves, so that the latching portions 2143 can rotate past the first stoper 291 and the second stoper 292 to continue to rotate.

In some embodiments, the first stopper 291 may be provided with a first operating portion 2911, and the second stopper 292 may be provided with a second operating portion 2921. The driving device 293 includes a telescopic rod 2931, and the telescopic rod 2931 is configured to apply force to the first operating portion 2911 and the second operating portion 2921 to drive the first stopper 291 and the second stopper 292 to rotate from the stop positions to the avoidance positions.

The working process of the dual-power transfer switch 100 is described below with reference to FIGS. 2 to 7.

Referring to FIGS. 2 and 3, both the first stopper 291 and the second stopper 292 are held in the stop position under the action of the holding mechanism. The contact assembly 30 is in the open state, and the movable contact 32 is away from the fixed contact 34. The first spring 261 and the second spring 262 are both in a compressed state, and apply force to the first driving shaft 251 and the second driving shaft 252, respectively, so that the mounting base 24 has a rotation tendency (a tendency to rotate in a counterclockwise direction in FIG. 2). At this point, the first driving shaft 251 is engaged with the first engaging groove 2141 of each driving plate 214 of the driving member 21, and each latching portion 2143 abuts against the first stoper 291 in the stop position, so that the driving member 21 is held in the ready-to-close position. The ready-to-close position is between the opening limit position and the closing limit position, and is close to the opening limit position. At this point, both the movable contact bracket 31 and the movable contact 32 are in a ready-to-close position.

Referring to FIGS. 4 and 5, the telescopic rod 2931 of the driving device 293 extends out, and drives both the first stopper 291 and the second stopper 292 to the avoidance position by pressing the first operating portion 2911 and the second operating portion 2921, so that neither the first stopper 291 nor the second stopper 292 interferes with the rotation of each latching portion 2143. The first spring 261 and the second spring 262 are both released from the compressed state shown in FIG. 2, and through the engagement between the first driving shaft 251 and the first engaging grooves 2141, and the driving member 21 is driven to perform the closing rotation around the axis of the pivot shaft 22 until the driving member 21 rotates to the closing limit position. When the driving member 21 rotates towards the closing limit position, it drives the movable contact bracket 31 to perform the closing rotation around the axis of the pivot shaft 33 through the output shaft 23 and the crank arm 38 until the movable contact 32 abuts against the fixed contact 34. At this point, the driving member 21, the movable contact bracket 31, and the movable contact 32 all reach the closing limit position, the movable contact 32 abuts against the fixed contact 34, and the contact assembly 30 is in the closed state.

Then, referring to FIG. 6, the telescopic rod 2931 of the driving device 293 retracts and no longer presses against the first operating portion 2911 and the second operating portion 2921. Both the first stopper 291 and the second stopper 292 return to the stop position under the action of the holding mechanism. For example, by means of applying a torque to the mounting base 24 through the first driving shaft 251 and the second driving shaft 252, the mounting base 24 is caused to rotate around the axis of the pivot shaft 22, so that the first driving shaft 251 is disengaged from the first engaging grooves 2141, and the second driving shaft 252 is engaged with the second engaging grooves 2142. At this point, the first spring 261 and the second spring 262 are still in a compressed state, and apply force to the first driving shaft 251 and the second driving shaft 252, respectively, so that the mounting base 24 has a rotation tendency (a tendency to rotate in a counterclockwise direction in FIG. 6). Each latching portion 2143 abuts against the second stoper 292 in the stop position, so that the driving member 21 remains in the ready-to-open position. The ready-to-open position is between the closing limit position and the opening limit position, and is close to the closing limit position. At this point, both the movable contact bracket 31 and the movable contact 32 are in the ready-to-open position. Meanwhile, the fixed contact 34 remains in abutment with the movable contact 32 under the action of the elastic biasing force of the contact pressure member, so that the contact assembly 30 is held in the closed state.

When the opening operation need to be performed, referring to FIG. 7, the telescopic rod 2931 of the driving device 293 extends out, and drives both the first stopper 291 and the second stopper 292 to the avoidance position by pressing the first operating portion 2911 and the second operating portion 2921, so that neither the first stopper 291 nor the second stopper 292 interferes with the rotation of each latching portion 2143. The first spring 261 and the second spring 262 are both released from the compressed state shown in FIG. 6, and through the engagement between the second driving shaft 252 and the second engaging grooves 2142, and the driving member 21 is driven to perform the opening rotation around the axis of the pivot shaft 22 until the driving member 21 rotates to the opening limit position. When the driving member 21 rotates towards the opening limit position, it drives the movable contact bracket 31 to perform the opening rotation around the axis of the pivot shaft 33 through the output shaft 23 and the crank arm 38 until both the movable contact support 31 and the movable contact 32 rotate to the opening limit position.

Afterwards, the telescopic rod 2931 of the driving device 293 retracts and no longer abuts against the first operating portion 2911 and the second operating portion 2921. The first stopper 291 and the second stopper 292 both return to the stop position under the action of the holding mechanism. For example, by means of applying a torque to the mounting base 24 through the first driving shaft 251 and the second driving shaft 252, the mounting base 24 is caused to rotate around the pivot shaft 22, so that the first driving shaft 251 is engaged with the first engaging grooves 2141, and the second driving shaft 252 is disengaged from the second engaging grooves 2142. The opening and closing mechanism 20 and the contact assembly 30 can then return to the state shown in FIGS. 2 and 3 to prepare for the next closing operation.

As can be seen from the above, the opening rotation and closing rotation of the movable contact 32 of the contact assembly 30 are indirectly driven by the elastic restoring force of the first spring 261 and the second spring 262. To ensure that the dual-power transfer switch 100 has good opening performance, the design of the first spring 261 and the second spring 262 needs to meet the requirement of enabling the contact assembly 30 to be opened quickly. It can be understood that, when the contact assembly 30 can be quickly opened under the action of the first spring 261 and the second spring 262, correspondingly, it can be quickly closed under the action of the first spring 261 and the second spring 262. That is, both the opening speed and closing speed of the movable contact 32 are relatively fast. For the fast transfer switch, the opening speed and closing speed of the movable contact 32 will be faster. In this way, during closing of the contact assembly 30, when the movable contact 32 abuts against the fixed contact 34, the movable contact 32 has a relatively high speed at the initial closing point, resulting in a relatively large impact force between the movable contact 32 and the fixed contact 34.

To avoid excessive impact force between the movable contact 32 and the fixed contact 34 during closing of the contact assembly 30, which may cause deformation, wear or even damage to the movable contact 32 and the fixed contact 34 and thus affect the service life of the dual-power transfer switch, embodiments of the present disclosure further provides a dual-power transfer switch 100. Referring to FIGS. 8 to 14, the dual-power transfer switch 100 can reduce the speed of the movable contact 32 at the initial closing point during closing of the contact assembly 30, reduce the impact when the movable contact 32 abuts against the fixed contact 34, and does not affect the opening speed of the contact assembly 30.

FIGS. 8-10 illustrate a dual-power transfer switch 100 according to some embodiments of the present disclosure. FIG. 8 illustrates a schematic perspective view of a partial structure of the dual-power transfer switch 100. FIG. 9 illustrates a further schematic perspective view of the dual-power transfer switch 100 shown in FIG. 8, for ease of description, an opening and closing mechanism and a buffer mechanism are omitted in FIG. 9. FIG. 10 illustrates a partially exploded view of the opening and closing mechanism 20 and the buffer mechanism 40 shown in FIG. 9. FIG. 11 illustrates an enlarged schematic diagram of portion A in FIG. 10.

The dual-power transfer switch 100 includes a housing, and two opening and closing mechanisms 20 and two contact assemblies mounted on the housing. As described above, the housing may include the support 10. The structures of two opening and closing mechanisms 20 are substantially the same, and the structures of the two contact assemblies are substantially the same.

Referring to FIGS. 9 to 11, the opening and closing mechanism 20 includes a driving member 21, a pivot shaft 22, an output shaft 23, a mounting base 24, a first driving shaft 251, a second driving shaft 252, a first spring 261, a second spring 262, a first rod 271, a second rod 272, a first positioning pin 281, a second positioning pin 282, a first stopper, a second stopper, and a driving device. In the case of no conflict, the structure of the opening and closing mechanism 20 may refer to the structure of the opening and closing mechanism 20 shown in FIGS. 1 to 7 above.

Specifically, the driving member 21 is provided with a first hole 211 and a second hole 212. For example, the driving member 21 is U-shaped, and includes a first connecting plate (referring to the first connecting plate 213 shown in FIG. 1) and two opposite driving plates 214. The first hole 211 is disposed at an end of each driving plate 214 close to the first connecting plate, and the second hole 212 is disposed at an end of each driving plate 214 away from the first connecting plate. A latching portion 2143 is formed at the end of each driving plate 214 away from the first connecting plate 213. A first engaging groove 2141 is formed on a side of each driving plate 214, and a second engaging groove 2142 is formed on the other side of each driving plate 214.

The mounting base 24 is provided with a first through hole 2411, a second through hole 2412, and a third through hole 2413 (referring to FIG. 2), and the first through hole 2411 is located between the second through hole 2412 and the third through hole 2413. More specifically, the mounting base is U-shaped, and includes a second connecting plate (referring to the second connecting plate 242 shown in FIG. 1) and two opposite mounting plates 241. The first through hole 2411, the second through hole 2412, and the third through hole 2413 all penetrate through the two mounting plates 241. The two mounting plates 241 are located outside the two driving plates 214.

The pivot shaft 22 is sleeved in the first hole 211 of each driving plate 214 and the first through hole 2411 of each mounting plate 241. A first end of the pivot shaft 22 is pivotally connected to a hole 101 of the support 10, so that the pivot shaft 22 can rotate around its own axis. The pivot shaft 22 is pivotally connected to the first through hole 2411 of each mounting plate 241, so that the mounting seat 24 can rotate relative to the pivot shaft 22.

A first end of the output shaft 23 is sleeved in the second hole 212 of each driving plate 214. The middle of the output shaft 23 passes through a second arcuate groove 12 on the support 10, and a second end of the output shaft 23 is connected to a movable contact bracket of a contact assembly (referring to the contact assembly 30 shown in FIG. 1) through a crank arm (referring to the crank arm 38 shown in FIG. 1). In the case of no conflict, the structure of the contact assembly may refer to the structure of the contact assembly 30 shown in FIGS. 1 to 7 above, and details will not be described herein again. When the driving member 21 performs a closing rotation or an opening rotation, the output shaft 23 drives the movable contact bracket to rotate via the crank arm, so that the movable contact abuts against or be separated from a corresponding fixed contact. In some embodiments, a spacer member (not labeled in the figures) may be sleeved on a portion of the output shaft 23 between the two driving plates 214.

The first driving shaft 251 is sleeved in the second through hole 2412 of each mounting plate 241. As described above, the first driving shaft 251 can abut against the first engaging groove 2141 of each driving plate 214 to push the driving member 21 to perform the closing rotation.

A first end of the first rod 271 is located between the two mounting plates 241 and is pivotally connected to the first driving shaft 251. A second end of the first rod 271 is provided with an elongated hole 2710 (referring to FIG. 2). The first positioning pin 281 is positioned on the support 10 of the housing and passes through the elongated hole 2710 of the first rod 271. The first spring 261 is sleeved on the first rod 271 and is clamped between the first driving shaft 251 and the first positioning pin 281.

The second driving shaft 252 is sleeved in the third through hole 2413 of each mounting plate 241. As described above, the second driving shaft 252 can abut against the second engaging groove 2142 of each driving plate 214 to push the driving member 21 to perform the opening rotation.

A first end of the second rod 272 is located between the two mounting plates 241 and pivotally connected to the second driving shaft 252. A second end of the second rod 272 is provided with an elongated hole 2720 (referring to FIG. 2). The second positioning pin 282 is positioned on the support 10 of the housing and passes through the elongated hole 2720 of the second rod 272. The second spring 262 is sleeved on the second rod 272 and is clamped between the second driving shaft 252 and the second positioning pin 282.

With continued reference to FIGS. 9-11, the pivot shaft 22 is non-rotatably engaged with the first holes 211, so that the pivot shaft 22 is non-rotatably connected to the driving member 21. In this way, when the driving member 21 performs the closing rotation or the opening rotation around an axis of the pivot shaft 22, the pivot shaft 22 rotates around its own axis along with the driving member 21.

Different from the dual-power transfer switch 100 shown in FIGS. 1 to 7, the dual-power transfer switch 100 further includes a buffer mechanism 40. The buffer mechanism 40 specifically includes a one-way bearing (also referred to as a one-way clutch bearing) 41 and an flywheel 42. The one-way bearing 41 is sleeved on the pivot shaft 22, and the flywheel 42 is sleeved on the one-way bearing 41. That is, the flywheel 42 is sleeved on the pivot shaft 22 via the one-way bearing 41. The one-way bearing 41 is configured to allow the flywheel 42 to rotate along with the pivot shaft 22 and the driving member 21 when the driving member 21 performs the closing rotation. It can be understood that, when the driving member 21 performs the opening rotation, the flywheel 42 may not rotate along with the pivot shaft 22 under the action of the one-way bearing 41.

Thus, when the driving member 21 performs the closing rotation, the first spring 261 and the second spring 262 released from the compressed state not only push the driving member 21, the movable contact bracket 31, and the movable contact 32 to rotate, but also push the flywheel 42 to rotate via the pivot shaft 22. This helps to reduce the closing speed of the movable contact 32, and can significantly reduce the speed of the movable contact 32 at the initial closing point, thereby reducing the impact force between the movable contact 32 and the fixed contact 34 at the moment of contact. In addition, after the movable contact 32 abuts against the fixed contact 34, although the driving member 21 stops rotating, the flywheel 42 will continue to rotate, thereby dissipating the absorbed energy, which is beneficial to protecting the contact assembly 30. Conversely, when the driving member 21 performs the closing rotation, the flywheel 42 will not rotate along with the pivot shaft 22 under the action of the one-way bearing 41, so it will not affect the opening speed of the movable contact 32. Therefore, the opening performance is not affected while the closing performance is improved. In addition, when the movable contact bracket 31 and the driving member 21 rotate to the maximum opening distance, rebound will occur, and the rebound will drive the flywheel 42 to rotate. At this point, the flywheel 42 can suppress the rebound of the movable contact bracket 31 and the driving member 21, which is beneficial to arc extinction.

In the dual-power transfer switch 100 provided by embodiments of the present disclosure, the driving member 21 is non-rotatably connected to the pivot shaft 22 via the first hole 211, and the flywheel 42 is sleeved on the pivot shaft 22 via the one-way bearing 41 so as to increase the moment of inertia of the movable contact bracket 31 during closing rotation. Thereby, it is beneficial to reduce the closing speed of the movable contact 32 and the impact speed at the initial closing point, reduce the impact force between the movable contact 32 and the fixed contact 34 at the moment of contact, and thus protect the contact assembly 30. Moreover, the additional moment of inertia is effective during closing but ineffective during opening, and does not affect the opening speed of the movable contact 32, so that the closing performance of the dual-power transfer switch 100 is improved without affecting its opening performance.

Referring to FIGS. 10 and 11, an illustrative embodiment of a non-rotatable connection between the pivot shaft 22 and driving member 21 is shown. Specifically, a hole wall of the first hole 211 is provided with a first cut surface 2110, an outer peripheral wall of a first end of the pivot shaft 22 is provided with a second cut surface 2212, and the first cut surface 2110 mates with the second cut surface 2212 to limit a relative rotation between the driving member 21 and the pivot shaft 22. The number of the first cut surface 2110 and the number of the second cut surface 2212 may be set as required, and the number of the first cut surface 2110 and the number of the second cut surface 2212 may be the same or different, as long as the relative rotation between the driving member 21 and the pivot shaft 22 can be limited. For example, in some embodiments, the hole wall of the first hole 211 may be provided with one first cut surface 2110, and the pivot shaft 22 may be provided with one second cut surface 2212. Alternatively, in some embodiments, the hole wall of the first hole 211 may be provided with one first cut surface 2110, the pivot shaft 22 may be symmetrically provided with two second cut surfaces 2212, and it is sufficient that only one of the two second cut surfaces 2212 abuts against the first cut surface 2110.

In some embodiments, the diameter of the pivot shaft 22 is not uniform. The driving member 21 may be sleeved on the first end of the pivot shaft 22 with a smaller diameter, and the one-way bearing 41 may be sleeved on the second end of the pivot shaft 22 with a larger diameter. In addition, the second end of the pivot shaft 22 may further be provided with an axial limiting structure, which is used to limit the axial positions of the one-way bearing 41 and the flywheel 42 on the pivot shaft 22.

An illustrative embodiment of the axial limiting structure is shown in FIG. 10. Specifically, the axial limiting structure includes a limiting flange 2231 and a limiting groove 2232. The limiting flange 2231 protrudes outwardly from the outer peripheral wall of pivot shaft 22, to limit the one-way bearing 41 and flywheel 42 from moving towards the first end of the pivot shaft 22. The limiting groove 2232 is disposed on the outer peripheral wall of the pivot shaft 22 and is used for the mounting of a circlip 224, and the circlip 224 limits the one-way bearing 41 and the flywheel 42 from moving towards the second end of the pivot shaft 22. Of course, the axial limiting structure may have other embodiments, as long as it can limit the axial movement of the one-way bearing 41 and the flywheel 42 on the pivot shaft 22.

An illustrative embodiment of the flywheel 42 is shown in FIG. 10. Specifically, the flywheel 42 includes a sleeve portion 420 and a first wheel body 421. The sleeve portion 420 is sleeved on the one-way bearing 41. The first wheel body 421 extends outwardly from an outer peripheral wall of the sleeve portion 420. The first wheel body 421 may be integrally formed with the sleeve portion 420. A thickness of the first wheel body 421 is less than an axial length of the sleeve portion 420.

Referring to FIG. 8 again, in some embodiments, the two opening and closing mechanisms 20 of the dual-power transfer switch 100 may each be configured with a buffer mechanism 40, and the one-way bearings 41 of the two buffer mechanisms 40 are respectively sleeved on the pivot shafts 22 of the corresponding opening and closing mechanisms 20. In some embodiments, by reasonably setting the position of the first wheel body 421 of each flywheel 42 on the sleeve portion 420, the first wheel bodies 421 of the flywheels 42 of the two buffer mechanisms 40 are spaced apart by a predetermined distance in an axial direction, so that the two flywheels 42 (in an axial projection direction) partially overlap each other. This facilitates saving assembly space without reducing the size of the flywheel 42.

In some embodiments, the opening and closing rotation directions of the driving members 21 of the two opening and closing mechanisms 20 are opposite. For example, in some embodiments, the closing rotation direction of the driving member 21 on the left side is counterclockwise, and the closing rotation direction of the driving member 21 on the right side is clockwise. This facilitates the layout of the two opening and closing mechanisms 20 and thus saves assembly space.

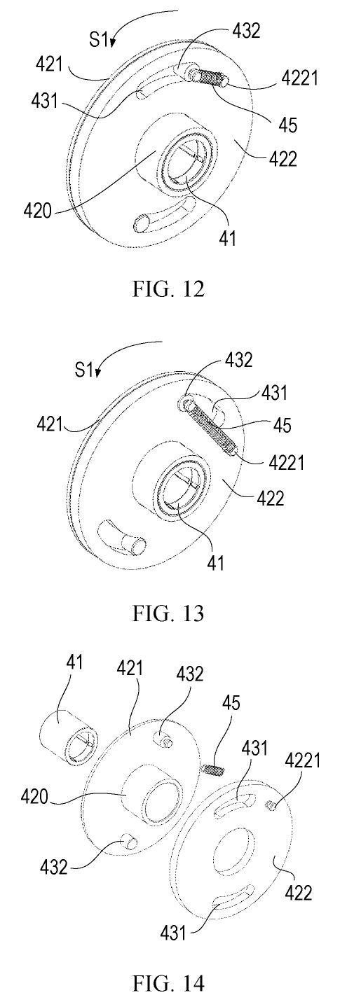

Of course, the embodiment of the flywheel 42 is not limited to the above examples. FIGS. 12 and 13 illustrate schematic perspective views of a variation of the buffer mechanism 40 shown in FIG. 9 from different viewing angles. FIG. 14 illustrates an exploded view of the buffer mechanism 40 shown in FIG. 12.

Referring to FIGS. 12 to 14, in some embodiments, the flywheel 42 may further include at least one second wheel body 422 sleeved on the sleeve portion 420. In some embodiments, an end of the at least one second wheel body 422 may be limited by the first wheel body 421, and the other end of the at least one second wheel body 422 may be limited by a circlip (not shown) mounted on the sleeve portion 420. Among the first wheel body 421 and the at least one second wheel body 422 stacked together, a linkage structure is disposed between every two adjacent wheel bodies. The linkage structure may be configured to: when the driving member 21 performs the closing rotation in the closing direction S1, allow one of every two adjacent wheel bodies to drive the other wheel body to rotate after rotating by a predetermined angle in the closing direction S1.

More specifically, taking the flywheel 42 provided with one second wheel body 422 as an example, when the driving member 21 performs the closing rotation in the closing direction S1, the first wheel body 421 rotates in the closing direction S1 along with the pivot shaft 22. After the first wheel body 421 rotates by a certain angle, the second wheel body 422 starts to rotate along with the first wheel body 421 under the action of the linkage structure. In this way, when the driving member 21 performs the closing rotation, the first wheel body 421 follows the pivot shaft 22 throughout the whole process, and the second wheel body 422 is driven by the first wheel body 421 to rotate along with the pivot shaft 22 after the first wheel body 421 rotates by a certain angle. It can be understood that, when the flywheel 42 is provided with two or more second wheel bodies 422, each second wheel body 422 sequentially rotates following the pivot shaft 22.

Since the driving member 21 only needs to drive the first wheel body 421 to rotate in the initial stage of the closing rotation, this is conducive to the rapid start of the rotation of the driving member 21, so as to obtain a shorter closing time. As the driving member 21 rotates for closing, it gradually drives each second wheel body 422 to rotate, thereby gradually increasing the moment of inertia of the movable contact bracket during its closing rotation, which is conducive to obtaining a lower speed at the initial closing point.

In some embodiments, the linkage structure may include at least one first arcuate groove 431 and at least one sliding block 432. The first arcuate groove 431 is disposed on one of every two adjacent wheel bodies. The sliding block 432 is disposed on the other of every two adjacent wheel bodies, and is slidably engaged with the at least one first arcuate groove 431. Referring to illustrative embodiment of the linkage structure shown in FIG. 14, the first arcuate groove 431 is specifically disposed on the second wheel body 422, and the sliding block 432 is specifically disposed on the first wheel body 421. Of course, the linkage structure may be implemented in a variety of ways and is not limited to the above examples, as long as the linkage structure enable the first wheel body 421 and each the second wheel body 422 to rotate in sequence when the driving member 21 performs the closing rotation.

In some embodiments, the linkage structure may include a plurality of first arcuate grooves 431 and a plurality of sliding blocks 432. The plurality of first arcuate grooves 431 and the plurality of sliding blocks 432 are uniformly arranged at intervals on the corresponding wheel bodies, respectively. This facilitates uniform stress on each wheel body during rotation.

In some embodiments, Among the first wheel body 421 and the at least one second wheel body 422 stacked together, a weight of the first wheel body 421 and the at least one second wheel body 422 gradually increases in a direction from the first wheel body 421 towards the second wheel body 422 away from the first wheel body 421. This facilitates obtaining a shorter closing time. Of course, in some embodiments, the weights of the first wheel body 421 and the at least one second wheel body 422 may be same. Alternatively, the weights of the second wheel bodies 422 may be same, and the weight of the second wheel body 422 may be greater than the weight of the first wheel body 421.

In some embodiments, an elastic return member is disposed between every two adjacent wheel bodies (for example, between the first wheel body 421 and an adjacent second wheel body 422, or between two adjacent second wheel bodies 422). Specifically, when the driving member 21 performs the closing rotation, the first wheel body 421 and the at least one second wheel body 422 rotate in sequence in the closing direction S1 under the action of the linkage structure, so that the elastic return member between every two adjacent wheel bodies is compressed or stretched. When the driving member 21 rotates to the closed position, and the at least one second wheel body 422 is no longer directly or indirectly driven by the first wheel body 421 to rotate in the closing direction S1, the elastic return member returns, so that each second wheel body 422 is reset, thereby providing buffering preparation for the next closing rotation of the driving member 21 and the movable contact bracket.

An illustrative embodiment of an elastic return member 45 is shown in FIGS. 12 to 14. The elastic return member 45 includes a spring, an end of the spring is connected to, for example, a sliding block 432 disposed on the first wheel body 421, and the other end of the spring is connected to, for example, the second wheel body 422 where the first arcuate groove 431 is located. More specifically, the second wheel body 422 may be provided with a fixing post 4221 for being connected to the spring. Referring to FIG. 12, when the flywheel 42 is in an initial position, the sliding block 432 is held at a first end of the first arcuate groove 431 by the elastic return member 45. Referring to FIG. 13, when the driving member 21 performs the closing rotation, the sliding block 432 may move to a second end of the first arcuate groove 431, the elastic return member 45 is stretched to the state shown in FIG. 13, and the first wheel body 421 drives the second wheel body 422 to rotate together in the closing direction S1. When the driving member 21 rotates to the closed position, and the first wheel body 421 no longer drives the second wheel body 422 to rotate in the closing direction S1 via the linkage structure, the stretched elastic return member returns, and the sliding block 432 is reset to the first end of the first arcuate groove 431, thereby providing buffering preparation for the next closing rotation of the driving member 21 and the movable contact bracket.

Of course, embodiments of the elastic return member 45 are not limited to the above examples. For example, in some embodiments not shown, the elastic return member 45 may be disposed in the first arcuate groove 431, an end of the elastic return member 45 may be connected to the sliding block 432, and the other end of the elastic return member 45 may be connected to an end of the first arcuate groove 431, and it can also drive each wheel body of the flywheel 42 to return to their original positions.

In the dual-power transfer switch provided by embodiments of the present disclosure, the driving member is non-rotatably connected to the pivot shaft via the first hole, and the flywheel is sleeved on the pivot shaft via the one-way bearing so as to increase the moment of inertia of the movable contact bracket during closing rotation. Thereby, it is beneficial to reduce a closing speed of the movable contact and an impact speed at an initial closing point, reduce the impact force between the movable contact and the fixed contact at the moment of contact, and thus protect the contact assembly. Moreover, the additional moment of inertia is effective during closing but ineffective during opening, and does not affect an opening speed of the movable contact, so that the closing performance of the dual-power transfer switch is improved without affecting its opening performance.

Various embodiments of the present disclosure have been described above, which are illustrative, not exhaustive, and are not limited to embodiments disclosed. Many modifications and variations will be apparent to those of ordinary skill in the art without departing from the scope and spirit of the illustrated embodiments. The selection of the terms used herein is intended to explain the principles of the embodiments, practical applications, or technical improvements in the marketplace, or to enable others of ordinary skill in the art to understand the embodiments disclosed herein.

1. A dual-power transfer switch, comprising:
a support;
an opening and closing mechanism comprising:
a driving member provided with a first hole; and
a pivot shaft sleeved in the first hole and non-rotatably engaged with the first hole, the pivot shaft being pivotally connected to the support to allow the driving member to perform a closing rotation or an opening rotation around an axis of the pivot shaft; and
a buffer mechanism comprising:
a flywheel; and
a one-way bearing, the flywheel being sleeved on the pivot shaft via the one-way bearing, and the one-way bearing being configured to allow the flywheel to rotate along with the pivot shaft when the driving member performs the closing rotation.

2. The dual-power transfer switch of claim 1, wherein:
a hole wall of the first hole is provided with a first cut surface, an outer peripheral wall of a first end of the pivot shaft is provided with a second cut surface, and the first cut surface mates with the second cut surface to limit a relative rotation between the driving member and the pivot shaft; and
the one-way bearing is sleeved on a second end of the pivot shaft.

3. The dual-power transfer switch of claim 1, wherein:
the driving member is sleeved on a first end of the pivot shaft,
the one-way bearing is sleeved on a second end of the pivot shaft, and
the second end of the pivot shaft is provided with an axial limiting structure for limiting axial positions of the one-way bearing and the flywheel on the pivot shaft.

4. The dual-power transfer switch of claim 1, wherein:
the driving member is further provided with a second hole, and
the opening and closing mechanism further comprises an output shaft, the output shaft is sleeved in the second hole and is connected to a movable contact bracket, and the output shaft is configured to drive the movable contact bracket to rotate when the driving member performs the closing rotation or the opening rotation, such that the movable contact abuts against or is separated from a corresponding fixed contact.

5. The dual-power transfer switch of claim 1, wherein the dual-power transfer switch is provided with two opening and closing mechanisms and two buffer mechanisms, and the one-way bearing of each buffer mechanism is sleeved on the pivot shaft of a corresponding opening and closing mechanism.

6. The dual-power transfer switch of claim 5, wherein the flywheels of the two buffer mechanisms partially overlap each other.

7. The dual-power transfer switch of claim 1, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.

8. The dual-power transfer switch of claim 7, wherein:
the flywheel further comprises at least one second wheel body sleeved on the sleeve portion, and
among the first wheel body and the at least one second wheel body stacked together, a linkage structure is disposed between every two adjacent wheel bodies, and the linkage structure is configured to: when the driving member performs the closing rotation in a closing direction, allow one of every two adjacent wheel bodies to drive the other wheel body to rotate after rotating by a predetermined angle in the closing direction.

9. The dual-power transfer switch of claim 8, wherein the linkage structure comprises:
at least one first arcuate groove disposed on one of every two adjacent wheel bodies; and
at least one sliding block disposed on the other of every two adjacent wheel bodies, and slidably engaged with the at least one first arcuate groove.

10. The dual-power transfer switch of claim 8, wherein an elastic return member is disposed between every two adjacent wheel bodies.

11. The dual-power transfer switch of claim 2, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.

12. The dual-power transfer switch of claim 11, wherein:
the flywheel further comprises at least one second wheel body sleeved on the sleeve portion, and
among the first wheel body and the at least one second wheel body stacked together, a linkage structure is disposed between every two adjacent wheel bodies, and the linkage structure is configured to: when the driving member performs the closing rotation in a closing direction, allow one of every two adjacent wheel bodies to drive the other wheel body to rotate after rotating by a predetermined angle in the closing direction.

13. The dual-power transfer switch of claim 12, wherein the linkage structure comprises:
at least one first arcuate groove disposed on one of every two adjacent wheel bodies; and
at least one sliding block disposed on the other of every two adjacent wheel bodies, and slidably engaged with the at least one first arcuate groove.

14. The dual-power transfer switch of claim 12, wherein an elastic return member is disposed between every two adjacent wheel bodies.

15. The dual-power transfer switch of claim 3, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.

16. The dual-power transfer switch of claim 15, wherein:
the flywheel further comprises at least one second wheel body sleeved on the sleeve portion, and
among the first wheel body and the at least one second wheel body stacked together, a linkage structure is disposed between every two adjacent wheel bodies, and the linkage structure is configured to: when the driving member performs the closing rotation in a closing direction, allow one of every two adjacent wheel bodies to drive the other wheel body to rotate after rotating by a predetermined angle in the closing direction.

17. The dual-power transfer switch of claim 4, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.

18. The dual-power transfer switch of claim 17, wherein:
the flywheel further comprises at least one second wheel body sleeved on the sleeve portion, and
among the first wheel body and the at least one second wheel body stacked together, a linkage structure is disposed between every two adjacent wheel bodies, and the linkage structure is configured to: when the driving member performs the closing rotation in a closing direction, allow one of every two adjacent wheel bodies to drive the other wheel body to rotate after rotating by a predetermined angle in the closing direction.

19. The dual-power transfer switch of claim 5, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.

20. The dual-power transfer switch of claim 6, wherein the flywheel comprises:
a sleeve portion sleeved on the one-way bearing; and
a first wheel body extending outwardly from an outer peripheral wall of the sleeve portion, wherein a thickness of the first wheel body is smaller than an axial length of the sleeve portion.
